(19) United States
(12) Patent Application Publication
(10) Pub. No.: US 2009/0138546 A1
(43) Pub. Date: May 28, 2009

(54) Device awareness; user profiling; profile storage, analysis and matching; and social interaction system for wireless mobile devices

(76) Inventor: Nazareno Brier Cruzada, Miami, FL (US)

Correspondence Address: NAZARENO CRUZADA, 1330 SW 104TH PATH # 210, MIAMI, FL, 33174, US

(21) Appl. No.: 11/944,621

(22) Filed: Nov. 25, 2007

(51) Int. Cl. G06F 15/16

(52) U.S. Cl. 709/203; 709/201

(57) ABSTRACT

This invention is an electronic communication system for wireless mobile devices and is utilized to scan for the existence of other wireless mobile devices, analyze and present information regarding user profiles associated with each device, and provide functionality to initiate possible social interactions between users of these devices.

### BACKGROUND OF THE INVENTION

1. Field of the Invention

All through history, people have sought to make human connections with others. The genesis and foundation of these connections range from similar interests, tastes and likes to having mutual friends or acquaintances. Each and every human relationship can be traced back to an initial contact and resulting connection. Since the dawn of time, humans have employed and relied on ways to create this initial contact from directly introducing one's self to the other person, to asking another person to make the introduction.

But for every successful connection, there are countless other ‘missed’ connections. Reasons for this include shyness, not knowing what to say, or not knowing anything about the other person's background (being perhaps a stranger at this point) to make a comment that is enticing or interesting enough to the other person. Even if a greeting is accomplished, nurturing an interesting conversation can be a challenge without a shared interest, topic, or common ground that both people find interesting.

2. Description of the Prior Art

Over the past decade, as the internet became popular and millions of people got ‘online’, web sites and chat programs helped people find others with similar tastes & interests and to communicate with them. These sites and programs allowed people to post information about themselves—their ‘profile’—and have others view it and contact them. Websites like Match.com, Chemistry.com, and eHarmony.com are three examples of hundreds of these sites.

Initially, these sites are full of promise & potential. Registering and browsing through the list of members makes one feel like a kid in a candy store. Unfortunately, this shining optimism is soon dimmed by an unexpected dark side. People find at some point that the person on the other end of the online connection isn't who they say they are. They may not be telling the truth about their age, gender, or physical build. Or perhaps the picture they posted online was from 10 years ago when they were still in shape. Whatever the case, there is usually a gap between the information posted online and reality.

To further compound the problem, the communication methods utilized by people making connections online easily allow people to misrepresent themselves. Email, instant messaging, or contact web pages provided by these websites have low fidelity when it comes to validating or verifying the truth about the person. These methods are not and cannot substitute face-to-face interaction and body language communication.

To help address this low fidelity process, some of these websites have added functionality to vet and qualify members before they can make connections or even register with the website. Examples of what websites do to provide some level of validation before a user can be registered include requiring a valid college or university email address, requiring a valid credit card, or simply requiring an application in person or that one be a member of a brick and mortar professional or civic organization. Other websites allow members to make a connection only thru a mutual friend or acquaintance who is already registered and is willing to vouch for or recommend that person. Other websites have the functionality of showing the ‘links’ or ‘degrees of separation’ between two users. This shared interest or ‘link’ between both parties can be enough to provide a higher level of trust for both parties or to allow them to establish a common ground or starting point for an online introduction or conversation.

Even so, online activities & communication can only be so effective. In the highly subjective and transitory world of dating & relationships, the physical element is hard to quantify in an online posting or profile. There are a lot of subtle and subconscious information that gets communicated via oral, aural, and body language cues during a physical encounter. As such, implementing this matching and linking technology to create human-to-human connections in real life, day-to-day situations will be a significant improvement over online connections.

### SUMMARY OF THE INVENTION

This invention is an electronic communication system for wireless personal mobile devices and is utilized to scan for existence of other wireless mobile devices, analyze and present information regarding user profiles associated with each device, and provide functionality to initiate possible social interactions between users of these devices.

The system allows user to create their own profiles or to retrieve their profiles from a plurality of online social networking or dating websites such as MySpace.com, Facebook.com, Match.com, or eHarmony.com or professional or civic organization websites and store them in a database on their personal mobile device to be available for matching with user profiles from other personal mobile devices.

The utility of this invention is that since this is implemented in real day-to-day situations, it provides an advantage over online or virtual user matching services, the advantage being that users can physically see each other and immediately know whether they are physically attracted to each other as opposed to looking at user's online profiles where user profile information and pictures may not be accurate.

Furthermore, this invention can promote & encourage human social interaction and connections—to give people in real world social situations the ability to ‘break the ice’ so to speak—by its implementation in personal wireless mobile devices that people carry with them everyday—such as smart phones, personal digital assistants (PDAs), or Pocket PCs.

### DETAILED DESCRIPTION OF THE INVENTION

The invention is an electronic communication system that is comprised of:
1. a central server application
2. a program that is installed & running on a wireless device
3. matchmaking algorithms that can identify matches between two user profiles
4. a database that stores user profiles—also installed on the wireless device

The central server application allows users to configure their user profile or profiles and to download them to their mobile device. The application provides screens that allow a user to enter and update a profile or to point to a website that already has their profile (such as a social networking website) and to extract specific data fields from that profile and to store these fields on a profile stored on their mobile device. This customized extraction process allows users to tailor the version of the profile stored on the mobile device so that sensitive or private information is taken out and not stored. This extraction process also allows the user to map particular fields from each website to standardized fields defined by the system. For example, the field ‘Hobbies’ can be defined in a particular social networking website as ‘Favorite Activities’. By defining standard field names and implementing this mapping process as part of the data extraction process, the system provides a unified platform for the storage and presentation of the user's profile data. If the user profile data is extracted from a website that vets or authenticates the user's profile information, then the user is prevented from editing the profile data. This user profile data is then encrypted and the encrypted data is what is downloaded to and stored in the database on the mobile device. The storing of the user profile data in encrypted format in the mobile device further prevents the user from altering or editing that data.

The program that is installed & running on the wireless device is responsible for several tasks. These include providing screens for the user to manually enter or update a profile directly into the mobile device, sending out electronic wireless signals from the device it is installed in, scanning a local area to search for the existence of other wireless devices by scanning for wireless signals emanating from other devices, showing a graphical map image outlining locations of both devices, providing a network service capable of wireless messaging functionality between the mobile devices, presenting a network service that provides user profile data associated with the device it is running on, executing algorithms that identify matches between both users' profiles, and presenting the match results to the user of the device.

Matchmaking algorithms can be downloaded from the central server application into the mobile device and executed by the program on the device. Executed, these algorithms will return the results of the match process, which the program will present to the user of the device via visual and/or audio cues. These algorithms can use all the fields or just the designated fields of a user's profile or profiles to find these matches.

These profiles are stored in a database installed on the mobile device and this database allows the user to designate specific fields to be used by the matching algorithm. The user can also turn on or off the functionality of communicating with other devices for the purpose of matching user profiles (promiscuous/non-promiscuous mode) as well as the functionality of providing user profile data to another device. This can be set in both the program's network service configuration settings as well as in the database.

In an example of the system's function, the software program running on a first wireless device can scan a local area searching for the existence of other wireless devices that have a similar profile-matching program. The software program running on the first device can then send an electronic wireless message request to retrieve user profile data to the program running on the second device. By making a call to the network service of the program running on the second device, it is able to retrieve user profile data from the second device, analyze the retrieved user profile data for possible matches or connections with user profile data of first device, and then present a match analysis report to user of first device.

This interaction and communication between both devices is bi-directional, meaning that the program running on the second device can simultaneously do the same actions that the program running on the first device is doing. So, while the program of the first device is scanning for other devices and requesting user profile data from the program of the second device, the program running on the second device can also be scanning the local area and requesting the program of the first device the same user profile data request.

When it comes to generating matches, this application recognizes that there are many different matchmaking algorithms. One example is to check user profile fields of both users to see if there is a match in values. If both users went to the same college, the program registers a match for the School field and can either present an alert to the user that there is a match on the School field or show the name of the school or both. In another example, the algorithm checks the user's connections or ‘friend’ links to see if both users have mutual friends or business contacts. If there is a match, then the program notifies the user and presents the name of the mutual connection. In both cases, the user is presented with the match results and can then use this information to approach and initiate a personal face-to-face conversation with the other user—a way of ‘breaking the ice’. Whatever the case, this invention provides the capability and flexibility to load and use different matchmaking algorithms and to change them at will. This means that one wireless mobile device may use one type of algorithm while another device may use a different matchmaking algorithm.

### BRIEF DESCRIPTION OF THE DRAWINGS

FIG. 1 is a high level diagram of the system including the setup, composition, linkages, and relationships of the central server application as well as the setup, composition, linkages, and relationships of the first and second wireless mobile devices.

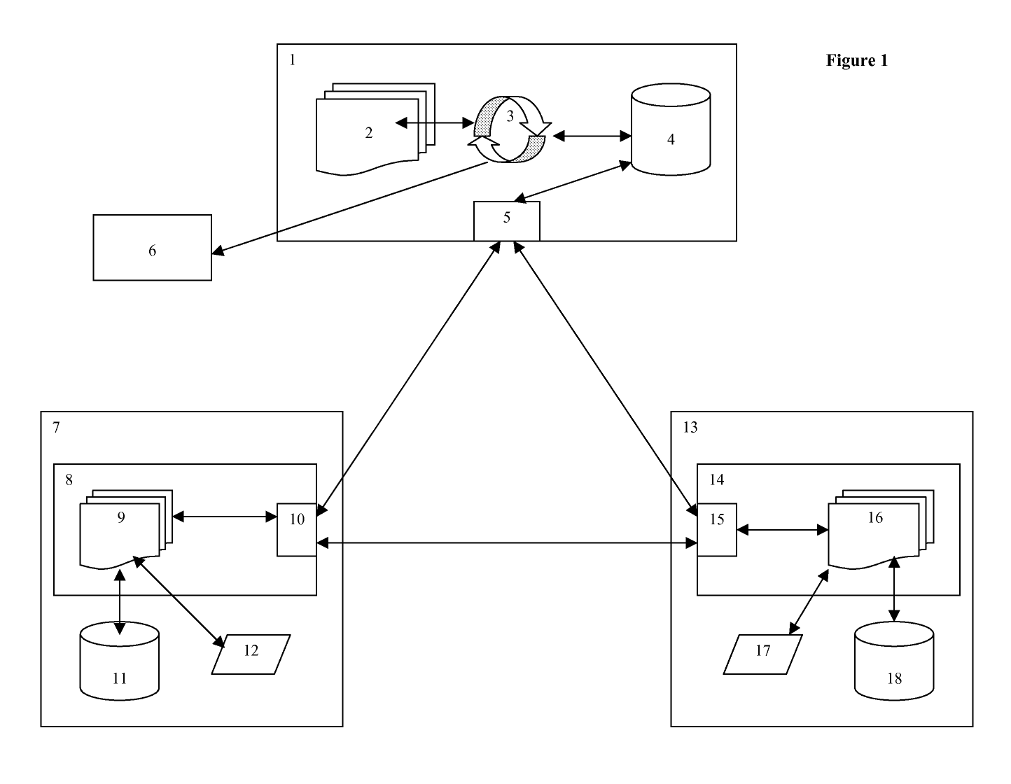

The components of the system as outlined in the drawing are:
1. The central server application
2. The screens for adding, retrieving or updating user profiles
3. Extraction and mapping process for user profile data from external website
4. Central server application database to store encrypted user profile data
5. Central server application network service for downloading user profile data to the wireless mobile device
6. External website containing user profile data
7. First wireless mobile device
8. Program installed on first wireless mobile device
9. Screens for adding or updating user profile data on first wireless mobile device
10. Network service on first wireless mobile device
11. Database for storing encrypted user profile data on first wireless mobile device
12. Matchmaking algorithm used by first wireless mobile device
13. Second wireless mobile device
14. Program installed on second wireless mobile device
15. Screens for adding or updating user profile data on second wireless mobile device
16. Network service on second wireless mobile device
17. Matchmaking algorithm used by second wireless mobile device
18. Database for storing encrypted user profile data on second wireless mobile device

What is claimed is:

1. An electronic communication system that is comprised of:
a) a central server application;
b) a program that is installed & running on a first and second wireless device;
c) matchmaking algorithms that can identify matches between two user profiles;
d) a database that stores user profiles installed on both wireless devices

2. A central server application that allows users to configure their user profile or profiles and to download them to their mobile device. The application provides screens that allow a user to enter and update a profile or to point to a website that already has their profile (such as a social networking website) and to extract specific data fields from that profile and to store these fields on a profile stored on their mobile device.

3. A method of the device of claim two wherein the extraction process allows users to tailor the version of the profile stored on the mobile device so that sensitive or private information is taken out and not stored.

4. A method of the device of claim two wherein the user profile data extraction process of the central server application allows the user to map particular fields from each website to standardized fields defined by the system. For example, the field ‘Hobbies’ can be defined in a particular social networking website as ‘Favorite Activities’. By defining standard field names and implementing this mapping process as part of the data extraction process, the system provides a unified platform for the storage and presentation of the user's profile data.

5. A method of the device of claim 2 wherein the user profile data extraction process of the central server application prevents the user from editing the profile data if the user profile data is extracted from a website that vets, validates or authenticates the user's profile information.

6. A method of the device of claim 2 wherein the user profile data extraction process of the central server application encrypts the user profile data and provides the ability to download to and store this data in the database on the mobile device via a network service.

7. A software program that is installed & running on a first & second wireless devices that provides wireless electronic communication between both devices.

8. A method of the device of claim 7 wherein the software program provides screens for the user to manually enter or update a profile directly into the mobile device.

9. A method of the device of claim 7 wherein the software program sends out electronic wireless signals

10. A method of the device of claim 7 wherein the software program scans a local area to search for the existence of other wireless devices by scanning for wireless signals emanating from other devices

11. A method of the device of claim 7 wherein the software program provides a network service capable of wireless messaging functionality between the mobile devices

12. A method of the device of claim 7 wherein the software program presents a network service that provides user profile data associated with the device it is running on

13. A method of the device of claim 7 wherein the software program executes algorithms that identify matches between user profiles of first & second wireless devices, and presenting the match results to the user of the device

14. Matchmaking algorithms that can be loaded into the device of claim 7 and executed by the program. Executed, these algorithms will return the results of the match process, which the program will present to the user of the device via visual and/or audio cues. These algorithms can use all the fields or just the designated fields of a user's profile or profiles to find these matches.

15. A method of the device of claim 7 wherein the software program allows the user to load matchmaking algorithms unique, different and completely independent of the matching algorithms used by other wireless mobile devices in the system.

16. A database installed on the same mobile device that the device of claim 7 is installed on. This database allows the storage of multiple user profiles and allows the device of claim 7 to communicate with it.

17. A method of the device of claim 16 wherein the user profile data is stored in encrypted format to prevent the user from altering or editing that data.

18. A method of the device of claim 7 wherein the software program allows the user can to turn on or off the functionality of communicating with other devices for the purpose of matching user profiles (promiscuous/non-promiscuous mode) as well as the functionality of providing user profile data to another device.

19. A method of the device of claim 16 wherein the database has a configuration setting that allows the user to turn on or off the functionality of communicating with other devices for the purpose of matching user profiles (promiscuous/non-promiscuous mode) as well as the functionality of providing user profile data to another device.

20. A method of the device of claim 7 wherein the interaction and communication between the instances of the device running on both the first & second mobile devices is bi-directional, meaning that the program running on the second mobile device can simultaneously do the same actions that the program running on the first device is doing. So, while the program of the first device is scanning for other devices and requesting user profile data from the program of the second device, the program running on the second device can also be scanning the local area and requesting the program of the first device the same user profile data request.

21. A method of the device of claim 7 wherein the software program presents the profile matching results to the user via a visual interface or audio cue.
